(19) United States
(12) Patent Application Publication
(10) Pub. No.: US 2012/0144305 A1
(43) Pub. Date: Jun. 7, 2012

(54) METHOD AND APPARATUS FOR SIMULTANEOUSLY PRESENTING AT LEAST TWO MULTIMEDIA CONTENT ON A PROCESSING DEVICE

(75) Inventors: TYRONE D. BEKIARES, CHICAGO, IL (US); JAMES E. MATHIS, BARRINGTON, IL (US)

(73) Assignee: MOTOROLA, INC., Schaumburg, IL (US)

(21) Appl. No.: 12/962,464

(22) Filed: Dec. 7, 2010

(51) Int. Cl. G06F 15/16; G06F 3/01

(52) U.S. Cl. 715/733; 709/217

(57) ABSTRACT

A method and apparatus for simultaneously presenting at least two received multimedia content to a user is disclosed. At least one receiving device receives more or more multimedia content from at least one sending device. The at least one receiving device determines characteristics of each received multimedia content and operating condition on the at least one receiving device. The characteristics and the operating condition are used to retrieve a policy for presenting the received multimedia content to a user. When executed, the policy identifies whether two or more received multimedia content are to be simultaneously presented to the user.

### FIELD OF THE DISCLOSURE

The present disclosure relates generally to presenting multimedia content on one or more receiving devices associated with a user and more particularly to simultaneously presenting two or more multimedia content on one or more of the receiving devices according to policies executed on the receiving devices.

### BACKGROUND

Multimedia content is usually captured and presented by receiving devices, such as computers, smart phones, and other electronic devices. Multimedia content includes, for example, text, audio, still images, animation, video or a combination thereof. Multimedia content is typically sent to a receiving device via a wired or wireless broadband network. Broadband networks now have the capacity to simultaneously send two or more multimedia content to a receiving device. Although a user of the receiving device may simultaneously access and comprehend certain types of multimedia content, the ability of the user to access and understand two or more simultaneously presented multimedia content is often dependent on the user's operating context and the relationship between the simultaneously presented media. For example, when the user is idle, the user may watch a video stream while listening to a related audio stream. The user typically cannot safely watch the video stream and listen to a related audio stream while driving a car, but they may be able to safely listen to just the audio stream. Accordingly, the user's operating context (in this example—being idle or driving a car) has an impact on how the user processes simultaneously presented multimedia content. In addition, the user also typically cannot effectively process both a video stream and unrelated audio content simultaneously. Thus, the relationship between the simultaneously presented multimedia content can also impact how the user processes simultaneously presented media.

While one or more receiving devices have the capacity to present two or more multimedia content simultaneously to a user, they do not schedule presentations of the received multimedia content based on the user's operating context and the relationship between the multimedia content queued for simultaneous presentation. As such, most receiving devices are configured to present received multimedia content queued for presentation in a sequential manner. For example, received audio streams queued for presentation may be presented in a playlist manner, where the audio streams are played sequentially, one after another. In another example, when a user is listening to music on a smart phone in a vehicle, the music may be paused while an incoming call is presented to the user.

Accordingly, there is a need for a method and apparatus for analyzing received multimedia content according to a user's operating context and the relationship between the received multimedia content queued for simultaneous presentation.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system whose operation includes simultaneously presenting at least two received multimedia content to a user in accordance with some embodiments.

FIG. 2 is a block diagram of a presentation component on a receiving device in accordance with some embodiments.

FIG. 3 is a flowchart of a method for simultaneously presenting two or more received multimedia content to a user in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to apparatuses and methods for simultaneously presenting at least two received multimedia content to a user. At least one receiving device receives more or more multimedia content from at least one sending device. The at least one receiving device determines characteristics of each received multimedia content and operating condition on the at least one receiving device. The characteristics and the operating condition are used to retrieve a policy for presenting the received multimedia content to a user. When executed, the policy identifies whether two or more received multimedia content are to be simultaneously presented to the user.

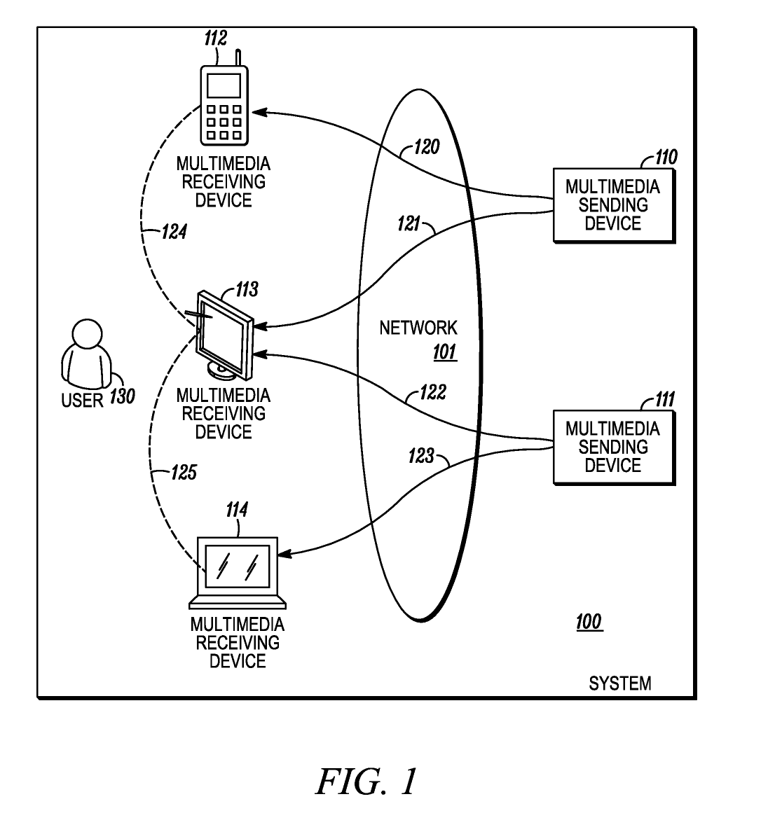

FIG. 1 is a block diagram of a system 100 whose operation includes simultaneously presenting at least two received multimedia content to a user in accordance with some embodiments. In some embodiments, system 100 employs one or more access networks 101 to interconnect one or more multimedia receiving and sending devices. Each access network 101 may include one or more wired or wireless segments to which the receiving and sending devices connect. The access networks 101 operate according to, for example, Institute of Electrical and Electronics Engineers (IEEE) 802.3, 802.11, or 802.16, Third Generation Partnership Project (3GPP) Long Term Evolution (LTE), 3GPP2 Code Division Multiple Access (CDMA), and other wireless and wired communication standards.

System 100 includes one or more multimedia devices 112-114, one or more of which may be configured to receive multimedia content, process multimedia content, present multimedia content, or any combination thereof. Multimedia devices 112-114 are configured to receive multimedia data from network 101 by means known in the art. In order to present multimedia content to a user, multimedia devices 112-114 may include components, such as displays and speakers, for presenting media content to the user and may include components, such as keyboards and screens for accepting input from the user. Multimedia devices 112-114 may be relatively stationary devices, such as desktop computers, televisions, or mobile or portable devices such as laptops, smart phones, portable digital assistants, two-way radios, and the like. One or more multimedia devices 112-114 may be associated with a single user 130. In some embodiments, one or more of the multimedia devices are configured to include a processing component to analyze and schedule simultaneous presentation of two or more received multimedia content, for example media streams, according to a policy. In instances where user 130 is associated with more than one multimedia device 112-114, received media characteristics and operating conditions from all devices associated with user 130 may be considered by the processing components when selecting an appropriate policy for allowing simultaneously presentation of received multimedia content to user 130. If more than one processing components on the associated multimedia devices are used to analyze and schedule simultaneous presentation of two or more received multimedia content, the processing components may be configured to coordinate the analysis and scheduling functions. For example, the processing components coordination may be based on predefined rules and/or pre-assigned priorities associated with each processing component, wherein a processing component with a higher priority may be configured to determine which analysis and scheduling functions are performed by each processing component on the associated multimedia devices. Associated multimedia devices may use any local or wide area networking technology known in the art, such as Bluetooth, Infrared, 802.11, ZigBee, and the like to coordinate processing and presentation of received multimedia pending simultaneous presentation, as shown by the lines 124-125.

System 100 also includes one or more multimedia sending devices 110-111. Multimedia sending devices 110-111 may be servers or other stationary devices or they may be mobile devices such as mobile digital video recorders, networked cameras, laptops, smart phones, and the like. One or more access networks 101 employed in system 100 connect multimedia sending devices 110-111 and multimedia receiving devices 112-114 to each other, as shown be lines 120-123. It should be appreciated that other components and configurations of system 100 are not shown for the sake of simplicity.

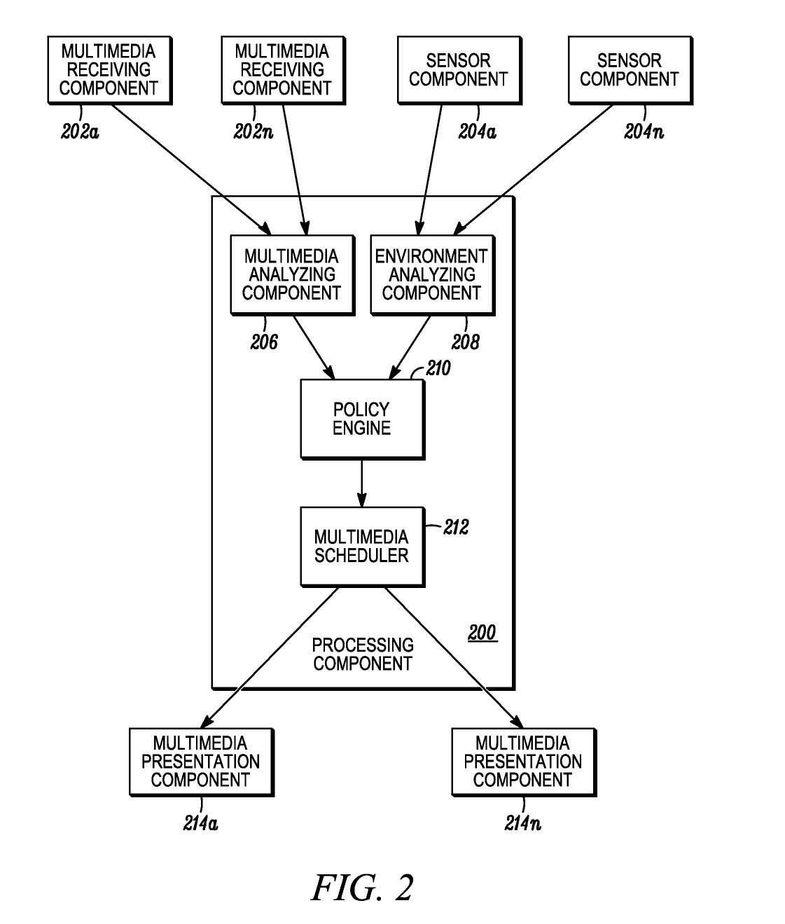

FIG. 2 is a block diagram of a processing component on a multimedia receiving device in accordance with some embodiments. The function of processing component 200 may be executed on one or more processors in a multimedia receiving device associated with a user, or may be distributed across one or more multimedia receiving devices associated with the user. Processing component 200 interacts with one or more multimedia receiving components 202a-202n for receiving one or more multimedia content from at least one sending device. In some embodiments, each multimedia receiving component 202a-202n is associated with a multimedia receiving device associated with the user. A multimedia receiving component, for example multimedia receiving component 202a, may be contained within the same multimedia receiving device as processing component 200. The multimedia content may be received through means known to those of ordinary skill in the art. Multiple multimedia content may be received by the multimedia receiving device at the same time or one or more of the multimedia content may be received before or after other multimedia content. Additionally, multiple multimedia content may be received through one or more multimedia receiving components, for example multimedia receiving component 202n, on a multimedia receiving device associated with the same user. In any case, two or more of the received multimedia content may be available for presentation to the user of the associated multimedia receiving devices at the same time.

A multimedia analyzing component 206 examines each received multimedia content and presents the parameters of the received multimedia content to a policy engine 210 where predefined or dynamically generated policies are executed. Parameters of the received multimedia content are characteristics of predefined features associated with the received multimedia content. Accordingly, multimedia analyzing component 206 examines each received multimedia content and determines the associated characteristics for the multimedia content. Examples of characteristics of a multimedia content include whether it is live or recorded, time duration, a priority, a source location, associated multimedia content, and an associated Computer Aided Dispatch (CAD) incident record. Another example of characteristics of a multimedia content includes the media type, for example audio or video. When the received multimedia content is a live media stream, the time duration may be an estimated time duration of the live media stream; otherwise, for example for a recorded media stream, the time duration may be the actual time duration of a received multimedia content. The estimated time could be provided by a source of the multimedia content. In some embodiments, the estimated time could be obtained by applying a heuristic associated with live media. For example, if the received multimedia content is an incoming video phone call, an associated heuristic for, for example the average time of a video phone call, could be used to obtain the estimated time for the video phone call. If, using another example, the receive multimedia content is a live surveillance media stream from an event which is scheduled to end at a specific time, the estimated time could be determined based on the specific end time.

In order to generate or provide an appropriate policy for the received multimedia content, policy engine 210 also obtains the operating context of the associated multimedia receiving device(s) from an environment analyzing component 208. In order to obtain the operating context of the associated multimedia receiving device(s), environment analyzing component 208 communicates with one or more sensor components 204a-204n that are configured to obtain information from one or more sensors such as, position sensors, proximity sensors, or sound sensor, associated with the user. One or more sensor components 204a-204n may be contained within the same multimedia receiving device as processing component 200, or may be contained within another multimedia receiving device associated with the same user. For example, using information obtained from available position sensors, such as an accelerometer, global positioning system, compass, or gyroscope, associated with multimedia receiving devices associated with the user, environment analyzing component 208 may determine if the user is currently performing other tasks, such as riding in a vehicle, riding a bike, or walking. Environment analyzing component 208 may also use information obtained from available proximity sensors, such as an infrared or eye tracking mechanism, to determine if the user is currently looking at the screen. Environment analyzing component 208 may also use information obtained from available sound sensors, such as a microphone, to determine noise levels, such as background noise level, at the multimedia receiving device. Environment analyzing component 208 may further use information obtained from available operating systems and application sensors on multimedia receiving devices used by the user, to determine concurrently running applications and activities on such devices.

Based on the characteristics of the multimedia content, as measured by multimedia analyzing component 206, and the operating conditions, as measured by the environment analyzing component 208, the multimedia analyzing component 206 and environment analyzing component 208 conveys the appropriate parameters to policy engine 210 where policies associated with scheduling of simultaneous presentation of multimedia content are retrieved. In particular, policy engine 210 retrieves at least one appropriate policy from a policy database based on the parameters received from multimedia analyzing component 206 and environment analyzing component 208. The retrieved policy is then conveyed to a multimedia scheduler component 212, where it is executed. The executed policy determines how the received multimedia content are scheduled for simultaneous presentation to the user. The actual presentation of the multimedia content may then be performed by one or more multimedia presentation components 214a-214n. Multimedia presentation components 214a-214n may be contained within the same multimedia receiving device as processing component 200, or may be contained within another multimedia receiving device associated with the same user.

Policies in the policy database may be predefined by the user or by another entity, such as an administrator or manufacturer, prior to multimedia content being available for presentation to the user. The policies may be entered into the policy database through means known to those skilled in the art. Policies in the policy database may also be dynamically generated by policy engine 210. For example, based on the parameters associated with a received multimedia content and/or the operating context on the multimedia receiving device, policy engine 210 may dynamically generate a new policy for simultaneously presenting the received multimedia content.

Upon obtaining the characteristics of the available multimedia content from the multimedia analyzing component 206 and the operating context of the multimedia receiving device from environment analyzing component 208, if, for example, the position sensors indicate that the user is stationary and there are multiple related video streams pending presentation, policy engine 210 may, for example, invoke a policy that presents related video streams simultaneously. Policy engine 210 may also, for example, invoke a policy to allow multiple pending audio streams to be simultaneously presented if the sound sensors indicate that the background noise level is sufficiently low. Policy engine 210 may also, for example, invoke a policy to prevent multiple pending video streams from being presented to the user simultaneously, if the operating system and applications sensors indicate that the user is actively entering data into a document, such as a Computer Aided Dispatch (CAD) record. It should be noted that the policies noted above are only examples. Policy engine 210 may be configured to invoke other policies that may or may not be similar to those described above.

Multimedia analyzing component 206 and environment analyzing component 208 may also determine the operating context of an associated device, network, or resource that is also available to the user by using one or more of the applicable sensors noted above. For example, multimedia analyzing component 206 may obtain information from, for example, multimedia receiving component 202n in an associated multimedia receiving device and determine the time duration of the multimedia content currently being presented or pending presentation. Multimedia analyzing component 206 may also determine the modality (e.g. audio or video) of the multimedia content currently being presented or pending presentation and may determine the relationship of the multimedia content currently being presented or pending presentation.

Upon determining the available multimedia content and operating context for all multimedia receiving devices associated with the user, policy engine 210 may, for example, invoke a policy to prevent display of a video stream if, for example, an associated/co-located two-way radio is engaged in an emergency call or if the user is driving a vehicle and certain features on the vehicle, for example an emergency light bar, are activated. Upon determining the time duration of the multimedia content, policy engine 210 may, for example, invoke a policy that allows two unrelated video streams to be presented simultaneously if, for example, one of the multimedia content is less than thirty seconds in duration. Policy engine 210 also may, for example, invoke a policy that allows one video and one audio stream to be presented simultaneously, but not two audio streams based on the mode of the multimedia content. In addition, policy engine 210 also may, for example, invoke a policy that allows two video streams, both capturing the same subject matter, such as an incident scene, but from different viewpoints, to be presented simultaneously, but not two unrelated video streams based on the relationship between the multimedia content currently being presented or pending presentation.

In addition, upon determining the available multimedia content and operating context for all multimedia receiving devices associated with the user, policy engine 210 may also invoke a policy to determine one or more of associated multimedia receiving devices on which the multimedia content is to be simultaneously presented. For example, if one multimedia receiving device associated with a user is a laptop which includes, for example multimedia receiving component 202a, a processing component 200, and a multimedia presentation component 214a, and another multimedia receiving device associated with a user is a smart phone which includes, for example multimedia presentation component 214n, policy engine 210 in the laptop may invoke a policy to present the multimedia content on the smart phone. As such, a policy engine on the laptop may schedule media for presentation on other multimedia receiving devices associated with the user.

In some embodiments, when a new multimedia content is made available for presentation to the end user, multimedia analyzing component 206 may determine if another multimedia content is already being presented to the user. If no other multimedia content is being currently presented, no further processing is performed in processing component 200. If another stream is being concurrently presented to the user, the multimedia analyzing component 206 may provide policy engine 210 with the parameters of the existing streams along with the parameters of the new stream. Policy engine 210 then uses information provided by the environmental analyzing component 208 and, combined with the multimedia content parameters, determines if the new multimedia content should be concurrently presented to the user. In some embodiments, policy engine 210 uses the information provided by the environmental analyzing component 208 and, combined with the multimedia content parameters, terminates display of the current multimedia content if the new multimedia content is determined to have a higher priority or otherwise prioritizes how the multimedia content are presented to the user.

An example of a policy that policy engine 210 could apply to multimedia content could be if the user is in a vehicle in motion, play only one audio and one video stream at a time. An example of another policy that could be applied is if a newly received multimedia content is less than thirty seconds in duration, play it concurrently with other video streams. An example of another policy that could be applied is if the user is in a quiet environment, play up to two audio streams simultaneously. An example of another policy that could be applied is to direct the multimedia scheduler to play all related video and audio streams (e.g. multiple views of the same incident, or audio-follow-video), but queue unrelated streams. An example of another policy that could be applied is if the user is filling out a CAD incident report, play only one audio and one video stream at a time. An example of another policy that could be applied is if a user's co-located two-way radio is playing audio from an emergency call, queue presentation of pending video streams. It should be noted that the policies noted above are only examples. Policy engine 210 may be configured to execute other policies that may or may not be similar to those described above. Policy engine 210 also may prioritize policies and may select a policy with a higher priority if two or more policies can be applied to two or more received multimedia content pending presentation. For example, policy engine 210 may assign a higher priority to live multimedia content than to recorded multimedia content. Policy engine 210 may also be configured to assign a higher priority based on the timeliness of received multimedia content, wherein the timeliness indicates the relationship between the time the multimedia content was captured, and the time it is to be presented. Policy engine 210 may also apply two or more policies to received multimedia content.

A given user, administrator, or manufacturer may optimize how the multimedia receiving device is configured to process multiple multimedia content pending presentation, thus ultimately increasing the efficiency of the user operating the multimedia receiving device. In some embodiments, the user, administrator, or manufacturer may configure policy engine 210 to allow simultaneous presentation of multimodal data emanating from a single multimedia receiving device. In other embodiments, the user, administrator, or manufacturer may configure policy engine 210 to allow simultaneous presentations of media from one or more co-located and associated multimedia receiving devices when two or more of multimedia content is directed to a single user. For example, an emergency call arriving on a two-way radio may preempt and delay simultaneous presentation of video displayed on a co-located terminal if both the two-way radio and terminal are being operated by the same user.

Those skilled in the art will appreciate that the sub components of processing component 200 may be further distributed across more than one multimedia receiving device available to a user. For example, multimedia analyzing component 206 may be collocated with multimedia receiving component 202 and not policy engine 210.

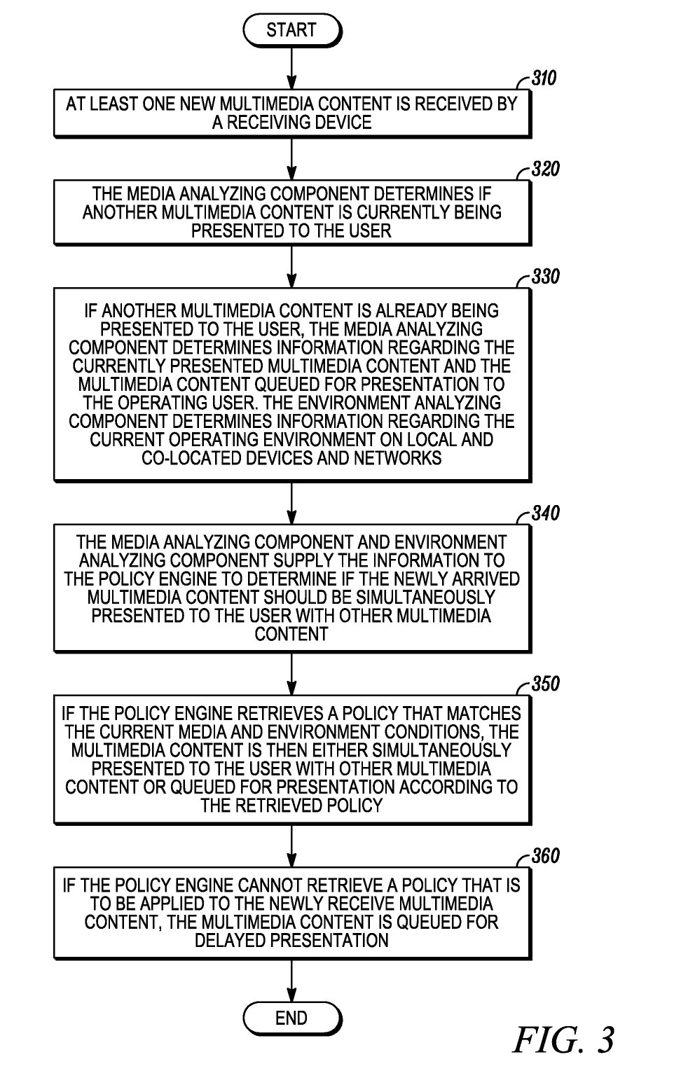

FIG. 3 is a flowchart of a method of simultaneously presenting received multimedia content to a user in accordance with some embodiments. In 310, at least one new multimedia content is received by a multimedia receiving device. The media is sent to the multimedia analyzing component. In 320, the multimedia analyzing component determines if another multimedia content is currently being presented to the user. In 330, if another multimedia content is already being presented to the user, the multimedia analyzing component determines information regarding the currently presented multimedia content and the multimedia content queued for presentation to the user. For example, the multimedia analyzing component determines parameters of other multimedia content currently being presented to the user and parameters for the newly received multimedia content from local and co-located devices and networks. The environment analyzing component determines information regarding the current operating environment on local and co-located devices and networks. For example, the environment analyzing component determines environmental information and a list of active applications and activities on local and co-located devices and networks. In 340, the multimedia analyzing component and environment analyzing component supply the information to the policy engine to determine if the newly arrived multimedia content should be simultaneously presented to the user with other multimedia content. In 350, if the policy engine retrieves a policy that matches the current media and environment conditions, the multimedia content is then either simultaneously presented to the user with other media or queued for presentation according to the retrieved policy. In 360, if the policy engine cannot retrieve a policy that is to be applied to the newly receive multimedia content, the multimedia content is queued for delayed presentation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for simultaneously presenting at least two received multimedia content to a user, the method comprising:
receiving, by at least one receiving device, at least two multimedia content from at least one sending device;
determining, by the at least one receiving device, characteristics of a received multimedia content and an operating condition of the at least one receiving device;
retrieving, by the at least one receiving device and dependent on the characteristics and the operating condition, a policy for presenting the received multimedia content to the user; and
executing the policy, by the at least one receiving device, wherein the policy identifies whether the at least two received multimedia content are to be simultaneously presented to the user.

2. The method of claim 1, wherein the determining further comprises determining if at least one other multimedia content is being presented to the user and providing characteristics of the at least one other multimedia content for use in retrieving the policy.

3. The method of claim 1, wherein the determining further comprises:
determining at least one of characteristics of multimedia content received by an associated device, network or resource or an operating context of the associated device, network or resource; and
providing at least one of the characteristics of multimedia content received by the associated device, network or resource or the operating context of the associated device, network or resource for use in retrieving the policy.

4. The method of claim 1, wherein the characteristics include at least one of a time duration of the received multimedia content, a type of the received multimedia content, a timeliness of the received multimedia content, or a relationship between the at least two received multimedia content,
wherein the time duration is one of an estimated time for a live multimedia content or an actual time for a recorded multimedia content, and wherein the timeliness indicates a relationship between a time the received multimedia content is captured and a time the received multimedia content is to be presented.

5. The method of claim 1, further comprising allowing the user of the at least one receiving device to predefine policies for presenting the received multimedia content prior to receiving the multimedia content on the at least one receiving device.

6. The method of claim 1, wherein at least one of the receiving, the determining, the retrieving or the executing is performed by a different receiving device associated with the user.

7. The method of claim 1, further comprising dynamically generating, in the at least one receiving device, predefined policies for presenting the received multimedia content to the user based on at least one of the characteristics of the received multimedia content or the operating condition of the at least one receiving device.

8. The method of claim 1, wherein determining the operating condition of the at least one receiving device comprises using position sensors to determine if the user of the at least one receiving device is currently moving.

9. The method of claim 1, wherein determining the operating condition of the at least one receiving device comprises using proximity sensors to determine if the user of the at least one receiving device is viewing a screen of the at least one receiving device.

10. The method of claim 1, wherein determining the operating condition of the at least one receiving device comprises using sound sensors to determine noise levels associated with the at least one receiving device.

11. The method of claim 1, wherein determining the operating condition of the at least one receiving device comprises using at least one of an operating system sensor or an application sensor to determine other concurrent activities on the at least one receiving device.

12. The method of claim 1, further comprising prioritizing policies to be applied to the received multimedia content and applying prioritized policies in determining whether the at least two received multimedia content are to be simultaneously presented to the user.

13. The method of claim 1, further comprising applying the policy to terminate display of a current multimedia content if a new multimedia content is determined to have a higher priority after determining that the at least two received multimedia content are not to be simultaneously presented to the user.

14. A receiving device for simultaneously presenting at least two received multimedia content to a user, comprising:
at least one receiving component configured to receive at least two multimedia content from at least other device;
a media analyzing component configured to determine characteristics of a received multimedia content;
an environment analyzing component configured to determine operating conditions of devices associated with the user;
a policy engine configured to use the characteristics and operating conditions to retrieve and execute a policy for determining whether the at least two multimedia content are to be simultaneously presented to the user; and
a scheduling component configured to simultaneously present the at least two multimedia content to the user according to the policy.

15. The receiving device of claim 14, wherein the media analyzing component is configured to determine if at least one other multimedia content is being presented and to provide characteristics of the at least one other multimedia content for retrieving the policy.

16. The receiving device of claim 14, wherein the environment analyzing component is configured to:
determine at least one of characteristics of multimedia content received by an associated device, network or resource or an operating context of the associated device, network or resource; and
provide at least one of the characteristics of multimedia content received by the associated device, network or resource or the operating context of the associated device, network or resource for use in retrieving the policy.

17. The receiving device of claim 14, wherein the media analyzing component is configured to determine a time duration of the received multimedia content, a type of the received multimedia content, a timeliness of the received multimedia content, and a relationship between the at least two multimedia content,
wherein the time duration is one of an estimated time for a live multimedia content or an actual time for the recorded multimedia content, and wherein the timeliness indicates the relationship between a time the received multimedia content is captured, and a time the received multimedia content is to be presented.

18. The receiving device of claim 14, wherein the policy engine is configured to generate the policy for simultaneously presenting the at least two multimedia content on one or more receiving devices associated with the user.

19. The receiving device of claim 14, wherein the receiving device is configured to coordinate functions of at least one of the media analyzing component, the environment analyzing component, the policy engine or the scheduling component with another receiving device associated with the user.

20. The receiving device of claim 15, wherein the environment analyzing component is configured to perform at least one of:
determine operating conditions of the at least one receiving device by using position sensors to determine if the user of the at least one receiving device is currently performing other tasks;
determine operating conditions of the at least one receiving device by using proximity sensors to determine if the user of the at least one receiving device is viewing a screen on the at least one receiving device;
determine operating conditions of the at least one receiving device by using sound sensors to determine noise levels associated with the at least one receiving device; or
determine operating conditions of the at least one receiving device by using operating system and application sensors to determine other concurrent activities on the at least one receiving device.
